(19) United States
(12) Patent Application Publication
(10) Pub. No.: US 2014/0087661 A1
(43) Pub. Date: Mar. 27, 2014

(54) HOME APPLIANCE USING TERMINAL AND OPERATING METHOD THEREOF

(71) Applicant: LG Electronics Inc., Seoul (KR)

(72) Inventors: Yanghwan Kim, Changwon-si (KR); Chulgon Tak, Changwon-si (KR); Jeonghan Kim, Changwon-si (KR); Minkyu Park, Changwon-si (KR)

(73) Assignee: LG Electronics Inc., Seoul (KR)

(21) Appl. No.: 14/035,458

(22) Filed: Sep. 24, 2013

(30) Foreign Application Priority Data
Sep. 24, 2012 (KR) 10-2012-0106032
Jan. 7, 2013 (KR) 10-2013-0001762

(51) Int. Cl. H04B 5/00

(52) U.S. Cl. CPC H04B 5/0025
USPC 455/41.1

(57) ABSTRACT

A home appliance using a mobile terminal is provided. The home appliance includes an input unit through which certain commands are input; a control unit controlling an operation of a driving unit of the home appliance according to the input through the input unit; and a near field communication (NFC) module connected to the mobile terminal to be able to communicate, wherein the NFC module comprises a memory unit that stores production information or state information on the home appliance, and if the NFC module is tagged to the mobile terminal, the NFC module transmits information from the memory unit to the mobile terminal.

### CROSS-REFERENCE TO RELATED APPLICATIONS

The present application claims priority under 35 U.S.C. 119 and 35 U.S.C. 365 to Korean Patent Application No. 10-2012-0106032 (filed on Sep. 24, 2012) and No. 10-2013-0001762 (filed on Jan. 7, 2013), which is hereby incorporated by reference in its entirety.

### BACKGROUND

The present disclosure relates to a mobile terminal, a home appliance and an operating method thereof, and more particularly, to a mobile terminal, a home appliance and an operating method thereof that may manage a home appliance even while the home appliance is turned off.

Among home appliances arranged in a building, a refrigerator keeps food, a washing machine does the laundry, an air conditioner controls an indoor temperature and a cooking device cooks food.

On the other hand, as various communication schemes develop, various techniques for enhancing user's convenience of use for home appliances through communication have been devised.

### SUMMARY

Embodiments provide electrical products that may be controlled by using portable terminals.

Embodiments also provide mobile terminals, home appliances and operating methods thereof that may manage home appliances even while the home appliances is turned off.

In one embodiment, a home appliance using a mobile terminal includes an input unit through which certain commands are input; a control unit controlling an operation of a driving unit of the home appliance according to the input through the input unit; and

a near field communication (NFC) module connected to the mobile terminal to be able to communicate, wherein the NFC module comprises a memory unit that stores production information or state information on the home appliance, and if the NFC module is tagged to the mobile terminal, the NFC module transmits information from the memory unit to the mobile terminal.

If the NFC module is tagged to the mobile terminal while the home appliance is turned off, the NFC module may transmit information from the memory unit to the mobile terminal.

The information transmitted to the mobile terminal may be transmitted to a server, and result information received from the server may be displayed on the mobile terminal.

A screen displayed on the mobile terminal may be an application screen executable for management or diagnosis of the home appliance.

When the screen displayed on the mobile terminal is a diagnosis screen for the home appliance, screen related information may be state information on the home appliance, and the result information may be diagnosis information based on the state information on the home appliance.

When the screen displayed on the mobile terminal is a product registration screen for the home appliance, the screen related information may be home appliance product information, and the result information may be product registration information.

When the screen displayed on the mobile terminal is a smart grid screen for the home appliance, the screen related information may be information on an amount of power consumption, and the result information may be recommendation operation information based on the power consumption amount information on the home appliance.

The control unit may control the NFC module to allow some of information generated from the home appliance to be displayed on the mobile terminal, said some of information being difficult to display on the home appliance.

The display unit of the mobile terminal may display at least one of: information transmitted from the mobile terminal to the home appliance or information transmitted from the home appliance to the mobile terminal, information on an operation course of the home appliance, information on an operation error of the home appliance, information on power consumption of the home appliance, and information on a link between the home appliance and a link device.

A plurality of operation commands that selection through the input unit is limited may be recognized by the control unit, and the terminal may include a terminal input unit that inputs the command selection-limited through the input unit and deliver the command to the control unit.

The home appliance may include a front unit on which the input unit and the NFC module are arranged, and the front unit may include a holding unit in which the terminal is detachably arranged.

The control unit may be configured to transmit or receive data from the mobile terminal through at least one transmission and reception mode, and the transmission and reception modes may include a first transmission and reception in which information inside the home appliance is transmitted to the mobile terminal, and the information inside the home appliance may include power consumption information or operation error information on the home appliance.

The transmission and reception mode may include a second transmission and reception mode in which information outside the home appliance is transmitted to the mobile terminal, and the information outside the home appliance may include information on an operation course of the home appliance.

The transmission and reception module may include a third transmission and reception mode in which operation information on two or more linkable devices is transmitted to the mobile terminal, and the two or more linkable devices may include a plurality of home appliances or one home appliance and a server.

The transmission and reception mode may include a fourth transmission and reception mode in which the home appliance changes a state to be on or off, and if the mobile terminal is tagged, the home appliance may change from an on state to an off state or from an off state to an on state.

The transmission and reception mode may include a fifth transmission and reception mode in which information on a preset my course, one of operation courses of the home appliance may be transmitted, and if the mobile terminal is tagged while the fifth transmission and reception mode is set, the control unit may control the driving unit to allow the home appliance to be driven according to said my course.

In another embodiment, a method of operating a home appliance includes executing an application by a mobile terminal; executing a transmission and reception mode for specific data through the application; tagging an NFC module of the mobile terminal to an NFC module of a home appliance; and transmitting information related to the home appliance from the home appliance to the mobile terminal, or from the mobile terminal to the home appliance.

If the home appliance is turned on, product information or state information on the home appliance may be stored in the NFC module of the home appliance, and if the tagging is performed while the home appliance is turned off, the information from the NFC module of the home appliance may be transmitted to the mobile terminal.

At least some of commands to be input for an operation of the home appliance may be input through only the mobile terminal of the home appliance and the mobile terminal.

The details of one or more embodiments are set forth in the accompanying drawings and the description below. Other features will be apparent from the description and drawings, and from the claims.

### BRIEF DESCRIPTION OF THE DRAWINGS

FIG. 1 is an example of a communication system configuration diagram according to an embodiment;

FIGS. 2A to 2E show various examples of near field communication (NFC) between a mobile terminal and a home appliance;

FIG. 3 is a simple internal block diagram of a home appliance of FIG. 1;

FIG. 4 is a diagram for explaining the NFC of FIG. 1;

FIG. 5 is an internal block diagram of a server of FIG. 1;

FIG. 6 is an internal block diagram of a mobile terminal of FIG. 1;

FIG. 7 is a flow chart of a method of operating a mobile terminal according to an embodiment;

FIG. 8 is a flow chart of a method of operating a home appliance according to an embodiment;

FIGS. 9 to 12F are diagrams for explaining the operating method of FIG. 7 or 8;

FIG. 13 shows a home appliance and a mobile terminal according to another embodiment;

FIG. 14 is a block diagram of a home appliance and a mobile terminal according to another embodiment;

FIG. 15 is a block diagram of a communication module of a home appliance according to another embodiment;

FIG. 16 is a flow chart of a method of controlling a home appliance according to another embodiment;

FIG. 17 is a block diagram of how information inside a home appliance is transmitted to a terminal according to another embodiment;

FIG. 18 is a block diagram of how outside information is transmitted to a home appliance according to another embodiment;

FIG. 19 is a flow chart of a method of controlling a home appliance according to another embodiment;

FIG. 20 is a block diagram of a home appliance and a mobile terminal according to another embodiment;

FIG. 21 shows a home appliance and a mobile terminal according to another embodiment; and

FIG. 22 shows a home appliance and a mobile terminal according to another embodiment.

### DETAILED DESCRIPTION OF THE EMBODIMENTS

Embodiments will be described below in detail with reference to the drawings.

The postfix “module” and “unit” for components to be used in the following description are just provided only for easiness in writing the specification and have no special meaning or function. Thus, the “module” and “unit” may be interchangeably used.

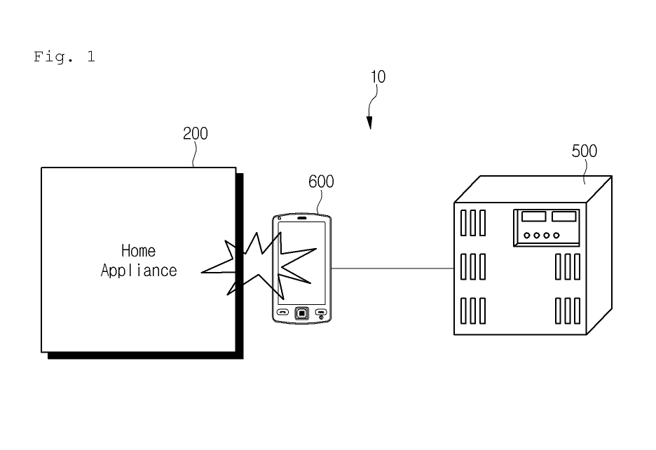

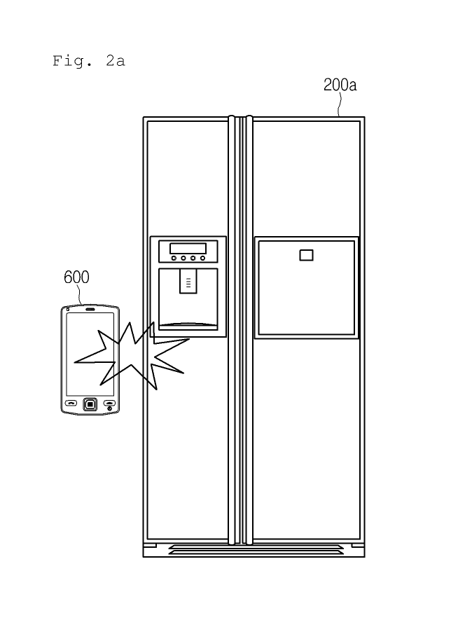

FIG. 1 is an example of a communication system configuration diagram according to an embodiment.

Referring to FIG. 1, a communication system 10 according to an embodiment may include a home appliance 200, a mobile terminal 600, and a server 500.

In particular, regarding the present embodiment, the home appliance 200 and the mobile terminal 600 may perform near field communication (NFC). In particular, while the power of the home appliance 200 is cut off, the home appliance 200 and the mobile terminal 600 may perform the NFC.

To that end, the home appliance 200 may frequently store home appliance related information. Subsequently, if the power of the home appliance 200 is cut off, the stored home appliance related information, such as state information or product information may be delivered to the mobile terminal 600 through the NFC.

Here, the state information may include operation period information, current operation time information, remaining operation time information, and current operation type information if the home appliance is being currently operated.

On the other hand, the state information may include information on broken parts at the time of failure, namely, information at the time of failure, and operation information at the time of failure, if the home appliance is out of order.

On the other hand, the state information may include power consumption information on the home appliance or cost information resulting from power consumption.

On the other hand, the product information may be a concept that includes product type information (refrigerator, washing machine, etc.), product manufactured date information, product serial number information, product's firmware type/version information on the home appliance.

On the other hand, the mobile terminal 600 may transmit, to the server 500, information received from the home appliance 200 that is turned off, and receive a transmission result. Accordingly, it is possible to easily manage the home appliance 200 by using the mobile terminal 600.

On the other hand, the home appliance 200 is an electronic device and may include, for example, a refrigerator 200a, a washing machine 200b, an air conditioner 200c, a cooling device 200d, a cleaner 200e, etc. In addition, the electronic device may include a TV though not shown.

On the other hand, the mobile terminal 600 may include a cellular phone, a smart phone, a notebook, a tablet PC, etc.

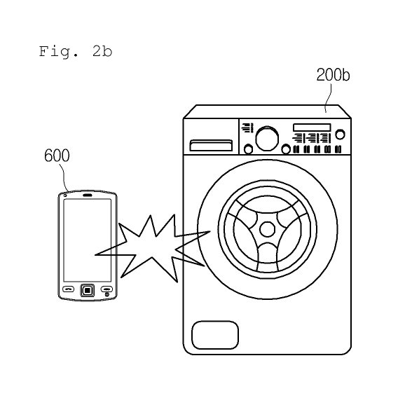

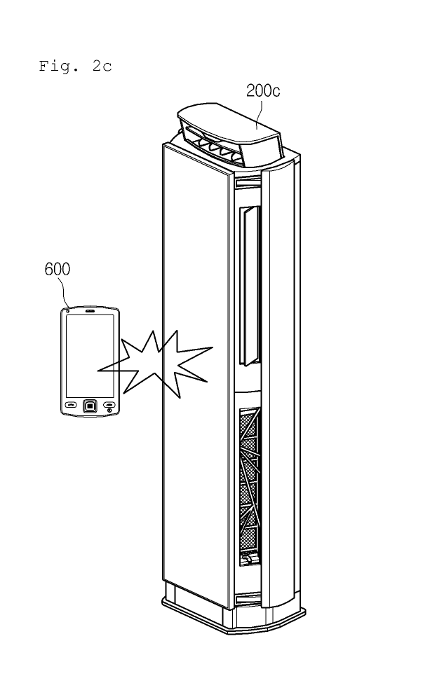

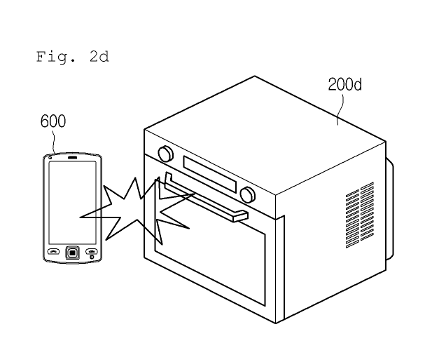

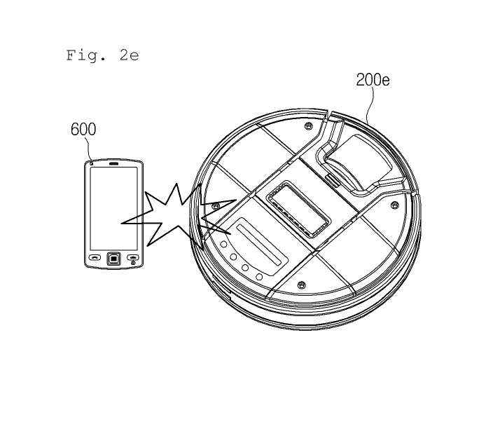

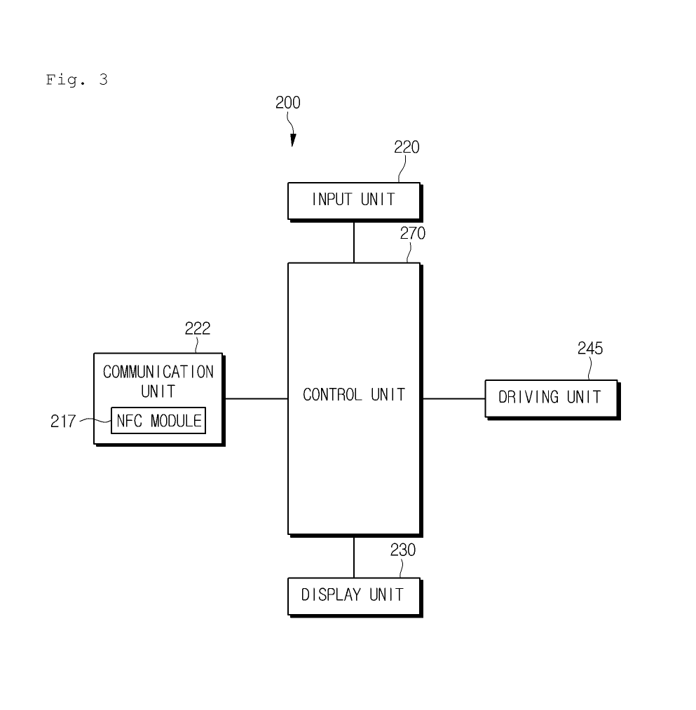

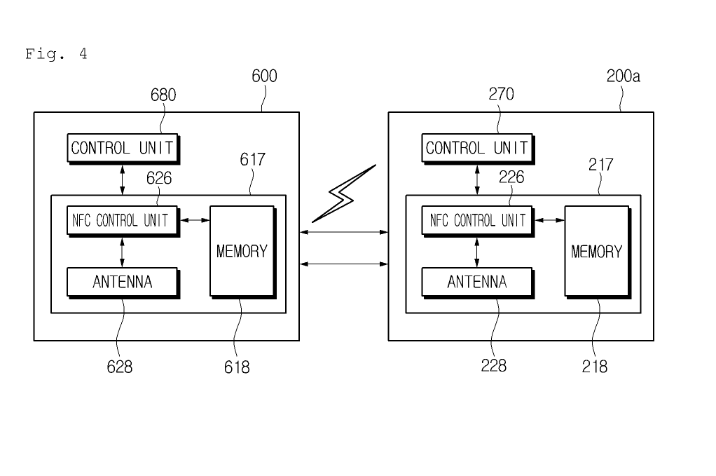

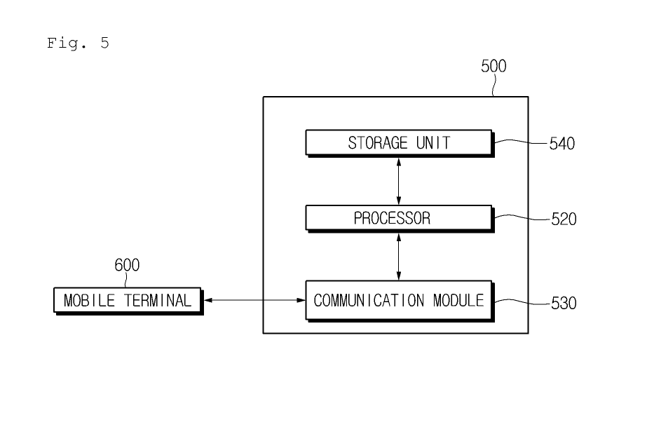

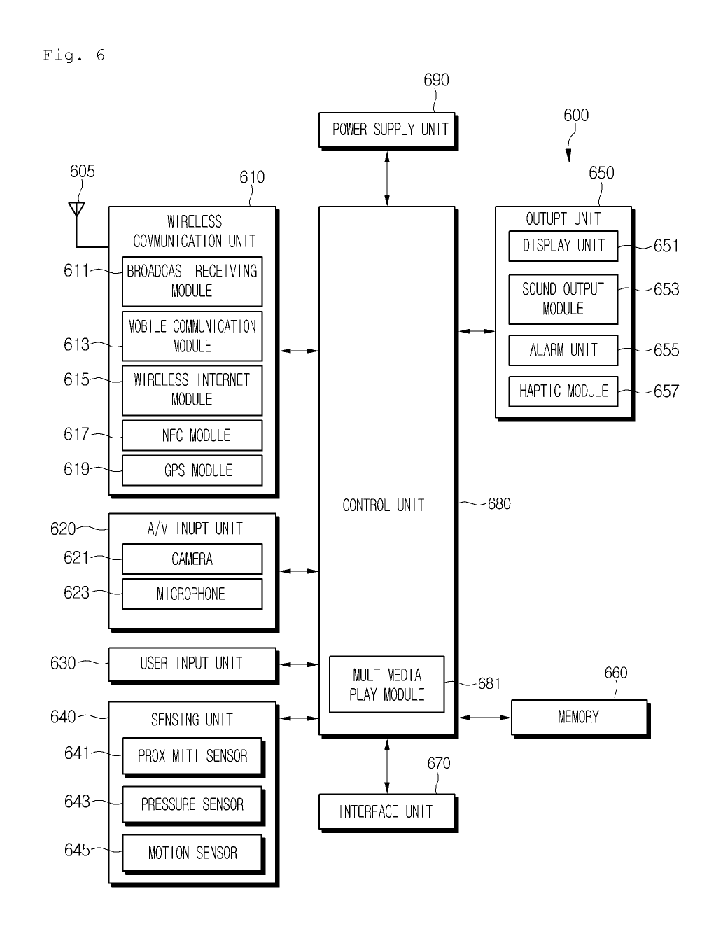

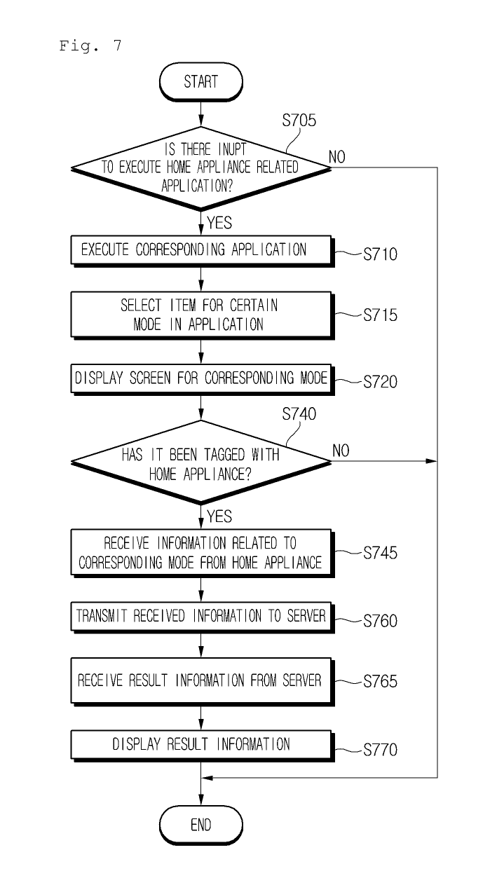

FIGS. 2A to 2E show various examples of near field communication (NFC) between a mobile terminal and a home appliance.

FIG. 2A exemplifies the NFC between the mobile terminal 600 and the refrigerator 200a, FIG. 2B exemplifies the NFC between the mobile terminal 600 and the washing machine 200b, FIG. 2C exemplifies the NFC between the mobile terminal 600 and the air conditioner 200c, FIG. 2D exemplifies the NFC between the mobile terminal 600 and the cooking device 200d, and FIG. 2E exemplifies the NFC between the mobile terminal 600 and the cleaner 200e.

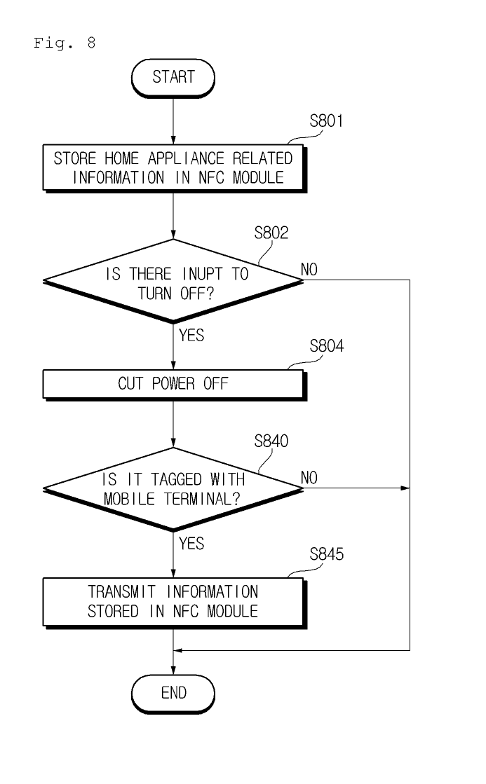

FIG. 3 is a simple internal block diagram of the home appliance of FIG. 1.

Referring to FIG. 3, the home appliance 200 my include an input unit 220 for a user input, a display unit 230 that displays the operation state of the home appliance, a communication unit 222 that communicates with other external devices, a driving unit 245 that drives the home appliance, and a control unit 270 for internal control.

The input unit 220 may include a power input unit that allows a user to input a turn on/off command, and a command input unit that allows a user to input a command related to the operation of the home appliance 200. The control unit 270 may control the operation of the driving unit 245 according to the command input from the input unit 220.

For example, when the home appliance is a refrigerator, the driving unit 245 may include a cooling compartment driving unit and a freezing compartment driving unit, and as an example, a motor that drives a compressor may be included in the driving unit 245.

As another example, when the home appliance is a washing machine, the driving unit 245 may be a driving unit that drives a drum or a tub, and as an example, a motor that rotates the drum may be included in the driving unit 245.

As another example, when the home appliance is an air conditioner, the driving unit 245 may include a compressor driving unit in an outdoor fan, an outdoor fan driving unit, and an indoor fan driving unit, and a motor may be included in the driving unit 245.

As another example, when the home appliance is a cooking device, the driving unit 245 may include a microwave driving unit that emits microwaves to a cavity, and a magnetron or transformer may be included in the driving unit 245.

As another example, when the home appliance is a cleaner, the driving unit 245 may include a fan driving unit, and a motor may be included in the driving unit 245.

On the other hand, the communication unit 222 may include at least an NFC module 217 that allows NFC.

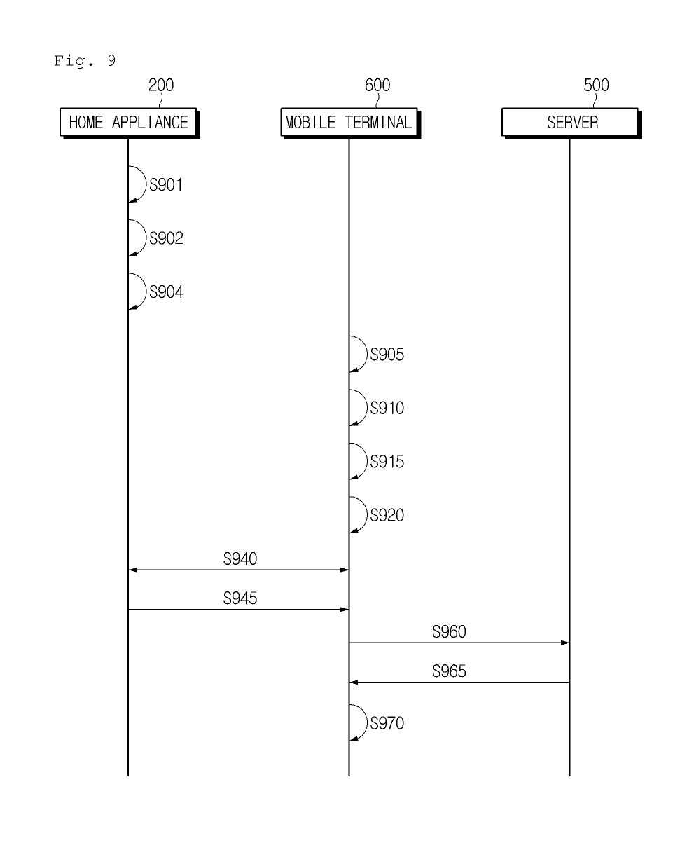

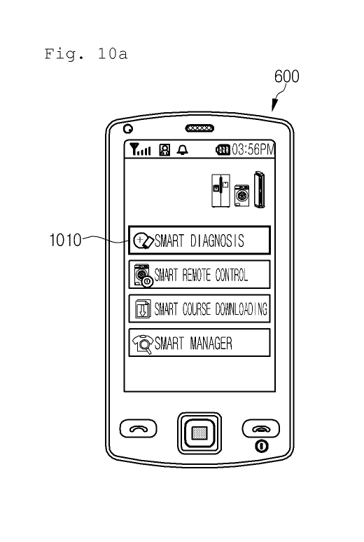

FIG. 4 is a diagram for explaining the NFC of FIG. 1.

Referring to FIG. 4, the mobile terminal 600 and the home appliance 200 may transmit or receive data by using an NFC scheme.

To that end, the mobile terminal 600 may include an NFC module 617 that includes an NFC memory, an NFC control unit 626, and an antenna 628.

Moreover, the home appliance 200 may include an NFC module 217 that includes an NFC memory 218, an NFC control unit 226, and an antenna 226.

For example, if a user moves the mobile terminal 600 to be within a predetermined distance from the home appliance 200, namely if the mobile terminal is tagged, a magnetic field is provided and the mobile terminal 600 may receive home appliance related information, for example, the state information or product information from the home appliance 200 depending on a change in magnetic field.

The information exchanged between the mobile terminal 600 and the home appliance may be performed based on a reader/writer mode or peer to peer mode of NFC among card emulation (CE) mode, reader/writer mode, and peer to peer mode of NFC.

On the other hand, FIG. 4 shows an active-type NFC module that includes the NFC control unit and the antenna, but alternatively, it is also possible to apply a passive-type NFC module that includes a tag-type NFC storage unit and an antenna. The active-type NFC module will be mainly described below.

The control unit 270 of the home appliance 200 or the NFC control unit 226 of the NFC module 217 allows home appliance related information, for example, state information or product information to be frequently stored in the NFC memory 218 of the NFC module 217, while being turned on. Thus, the NFC memory 218 of the NFC module 217 may store home appliance related information, for example, state information or product information while being turned on.

If the home appliance 200 is tagged while being turned off, the antenna 628 of the NFC module 617 of the mobile terminal 600 receives product information from the antenna 228 of the NFC module 217 of the home appliance 200.

If the received product information matches preset product information, the control unit 626 of the NFC module 617 of the mobile terminal 600 allows state information to be further read from the NFC module 217 of the home appliance 200. In particular, it allows state information to be read from the NFC memory 218 of the NFC module 217 of the home appliance 200.

In addition, the control unit 680 of the mobile terminal 600 may receive at least one of received product information and state information and allow the received information to be transmitted to the server 500.

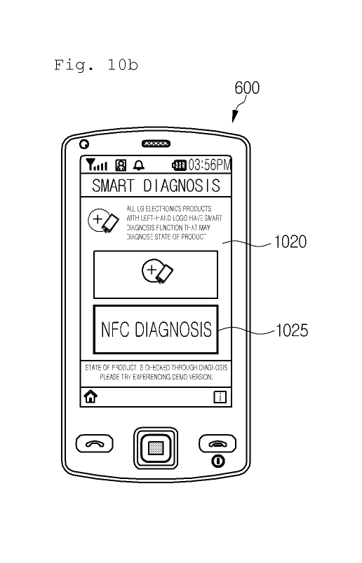

FIG. 5 is an internal block diagram of a server of FIG. 1.

Referring to FIG. 5, the server 500 may include a communication module 530, a storage unit 540, and a processor 520.

The communication module 530 may receive home appliance related information from the mobile terminal 600. In addition, the communication module 530 may transmit result information corresponding to the received home appliance related information to the mobile terminal 600.

To that end, the communication module 530 may include an internet module or a mobile communication module.

The storage unit 540 may store received home appliance related information and have data for generating result information corresponding to home appliance related information.

For example, when the home appliance related information is failure information on the home appliance, the storage unit 540 may store data for failure diagnosis of the home appliance.

On the other hand, as another example, when the home appliance related information is product information on the home appliance, the storage unit 540 may store received product information for product registration of the home appliance.

On the other hand, when the home appliance related information is power consumption information on the home appliance, the storage unit 540 may store power price information, on-peak-time power information, off-peak-time power information, real-time power information, etc.

The processor 520 may control the overall operation of the server 500.

On the other hand, if receiving home appliance related information from the mobile terminal 600, the processor 520 may allow result information corresponding to the home appliance related information to be generated. In addition, it may allow the generated result information to be transmitted to the mobile terminal 600.

For example, when the home appliance related information is failure information on the home appliance, the processor 520 may generate failure diagnosis result information on the home appliance by using failure diagnosis data stored in the storage unit 540.

On the other hand, as another example, when the home appliance related information is product information on the home appliance, the processor 520 may generate product registration result information on the home appliance.

On the other hand, as another example, when the home appliance related information is power consumption information on the home appliance, the processor 520 may allow power information to be transmitted to the mobile terminal as result information, the power information including power price information, on-peak-time power information, off-peak-time power information, real-time power information, etc. that are stored in the storage unit 540.

On the other hand, the server 500 may be a server that a manufacturer of the home appliance 200 operates, or a server that an application store operator related to the home appliance 200 operates.

FIG. 6 is an internal block diagram of a mobile terminal of FIG. 1.

Referring to FIG. 6, the mobile terminal 600 may include a wireless communication unit 610, an audio/video (A/V) input unit 620, a user input unit 630, a sensing unit 640, an output unit 650, a memory 660, an interface unit 670, a control unit 680, and a power supply unit 690.

On the other hand, the wireless communication unit 610 may include a broadcast receiving module 611, may include a broadcast receiving module 611, a mobile communication module 613, a wireless internet module 615, an NFC module 617, and a GPS module 619.

The broadcast receiving module 611 may receive at least one of a broadcast signal and broadcast related information from an external broadcast management server through a broadcast channel. In this case, the broadcast channel may include a satellite channel, a terrestrial channel, etc.

The broadcast signal and/or broadcast related information received through the broadcast receiving module 611 may be stored in the memory 660.

The mobile communication module 613 transmits and receives a wireless signal to and from at least one of a base station, an external terminal, and a server over a mobile communication network. Here, the wireless signal may include various forms of data for transmitting and receiving a voice call signal, a video call signal, or a text/multimedia message

The wireless internet module 615 indicates a module for a wireless internet access and may be installed inside or outside the mobile terminal 600. For example, the wireless internet module 615 may perform WiFi based wireless communication or a WiFi Direct based wireless communication.

The NFC module 617 may perform NFC. If the mobile terminal moves to be within a predetermined distance from the home appliance with an NFC tag or an NFC module, namely, if the home appliance is tagged, the NFC module 617 may receive or transmit data from or to a corresponding home appliance.

In addition, Bluetooth, Radio Frequency Identification (RFID), infrared Data Association (IrDA), Ultra Wideband (UWB), ZigBee, etc. may be used as the NFC technology.

The Global Position System (GPS) module 619 may receive position information from a plurality of GPS satellites.

The A/V input unit 620 is used for an audio signal or video signal input and may include a camera 621 and a microphone 623.

The user input unit 630 generates key input data that is input by a user to control the operation of a terminal. To this end, the user input unit 630 may include a key pad, a dome switch, and a (static pressure/static electricity) touch pad. In particular, when the touch pad forms a layer structure with the display unit 651, it may be called a touch screen.

The sensing unit 640 may sense the current state of the mobile terminal 600 such as the open/close state of the mobile terminal 600, the location of the mobile terminal 600, and whether the mobile terminal is in contact with a user, and generate a sensing signal for controlling the operation of the mobile terminal 600.

The sensing unit 640 may include a sensing sensor 641, a pressure sensor 643, and a motion sensor 645. The motion sensor 645 may sense the motion or location of the mobile terminal 600 by using an acceleration sensor, a gyro sensor, and a gravity sensor. In particular, the gyro sensor is a sensor for measuring angular velocity and may sense a direction (angle) rotated from a reference direction.

The output unit 650 may include the display unit 651, a sound output module 653, an alarm unit 655, and a haptic module 657.

The display 651 displays/outputs information processed by the mobile terminal 600.

On the other hand, when the display unit 651 and the touch pad form a layer structure to form a touch screen as described above, the display unit 651 may be used as an input unit that may input information by a user's touch, in addition to the output unit.

The sound output module 653 outputs audio data received from the wireless communication unit 610 or stored in the memory 660. Such a sound output module 653 may include a speaker, a buzzer, etc.

The alarm unit 655 outputs a signal for informing the occurrence of an event from the mobile terminal 600. For example, the signal may be output as a vibration.

The haptic module 657 generates various tactile effects that a user may feel. A typical example of the tactile effects that the haptic module 657 generates is a vibration effect.

The memory 660 may store programs for processing and controlling the control unit 680 and also temporarily store data (for example, a phone book, messages, still pictures and moving pictures) that is input or output.

The interface unit 670 performs an interface function between all external devices that are connected to the mobile terminal 600. The interface unit 670 may receive data or power from such external devices, deliver the data or power to each component in the mobile terminal 600, and allow data in the mobile terminal 600 to be transmitted to the external devices.

The control unit 680 typically controls the operation of each unit and controls the overall operation of the mobile terminal 600. For example, it is possible to perform control and processing related to a voice call, data communication, a video call, etc. Moreover, the control unit 680 may also include a multimedia play module 681 for playing multimedia. The multimedia play module 681 may be configured as hardware in the control unit 680 or as software separately from the control unit 680.

The power supply unit 690 receives external power or internal power by the control of the control unit 680 and supplies power required for operating each component.

On the other hand, a block diagram for the mobile terminal 600 as shown in FIG. 6 is a block diagram for an embodiment. Each component of FIG. 6 may be integrated, added or removed according to the specification of the mobile terminal 600 that is actually implemented. That is, tow or more components may be integrated into one component, or one component may be divided into two or more components, as needed. Moreover, each block's function is provided to describe the embodiment and its detailed operation or device does not limit the scope of a right of the present invention.

FIG. 7 is a flow chart of a method of operating a mobile terminal according to an embodiment, FIG. 8 is a flow chart of a method of operating a home appliance according to an embodiment, and FIGS. 9 to 12F are diagrams for explaining the operating method of FIG. 7 or 8;

Firstly, referring to FIG. 8, the home appliance sores home appliance related information in the NFC module in step S801. On the other hand, step S901 of FIG. 9 corresponds to step S801 of FIG. 8.

While the home appliance 200 is turned on, the control unit 200 of the home appliance may allow home appliance related information, for example, state information or product information to be stored in the NFC module 217.

For example, while the washing machine 200b is in operation, it is possible to store washing machine's operation time information, washing machine's operation course information, washing machine's failure determination information in the NFC module of the washing machine 200b.

On the other hand, the home appliance related information may be regularly stored in the NFC module 217 while the home appliance 200 operates.

Alternatively, the home appliance related information may be stored in the NFC module 217 on a first cycle at the initial operation of the home appliance 200 and then on a second cycle that is shorter than the first cycle.

Next, the home appliance determines whether there is an input to turn off, in step S802, and if positive, the home appliance is turned off in step S804. On the other hand, step S902 of FIG. 9 corresponds to step S802 of FIG. 8 and step S904 of FIG. 9 corresponds to step S804 of FIG. 8.

The control unit 270 of the home appliance determines whether there is an input to turn off through the input unit 220. Alternatively, the control unit 270 of the home appliance determines whether there is an input to turn off due to the failure of the home appliance.

If there is an input to turn off, the control unit 270, NFC module 217, and input unit 220 of the home appliance enter a standby mode and other units may enter a turn-off state. That is, the control unit 270 of the home appliance may allow power supplied to the display unit 230 and the driving unit 245 to be cut off.

On the other hand, referring to FIG. 7, the mobile terminal 600 determines whether there is an input to execute an application related to the turned-off home appliance, in step S705. In addition, if positive, a corresponding application is executed in step S710. On the other hand, step S905 of FIG. 9 corresponds to step S705 of FIG. 7 and step S910 of FIG. 9 corresponds to step S710 of FIG. 7.

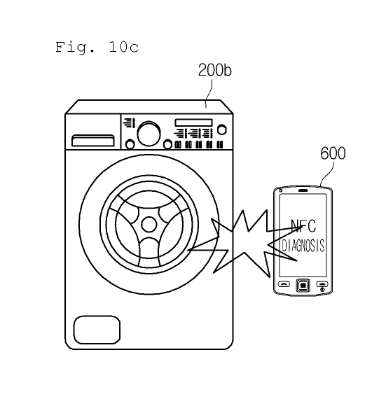

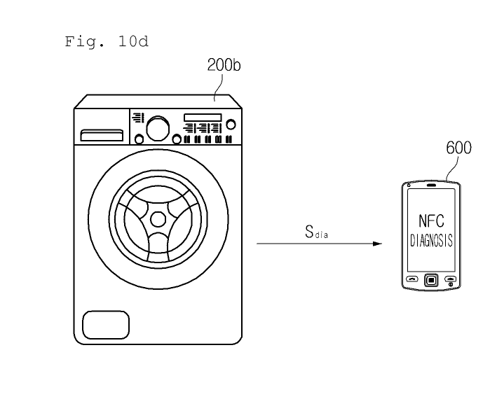

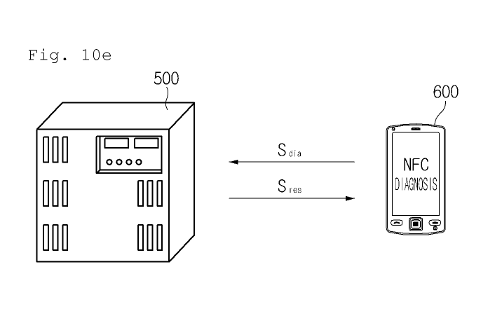

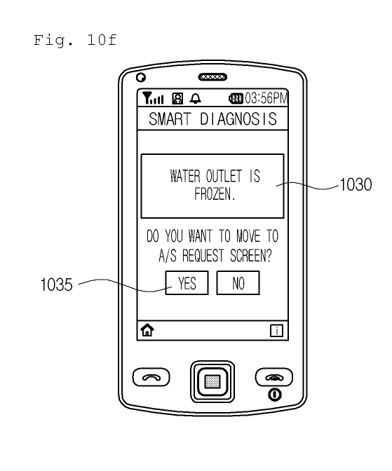

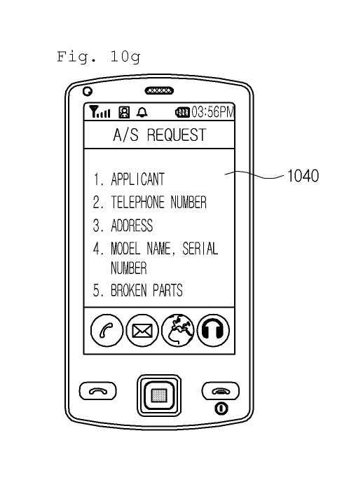

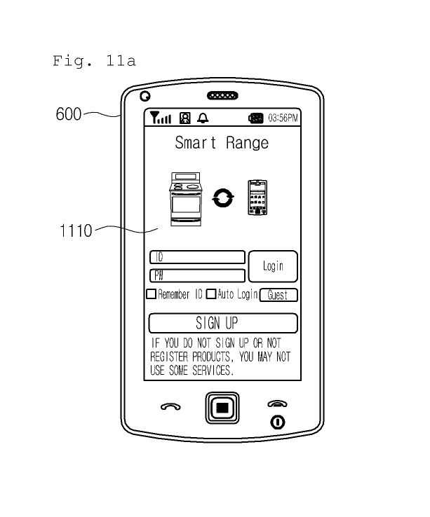

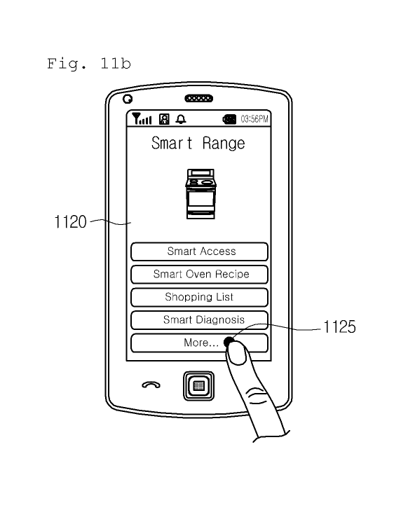

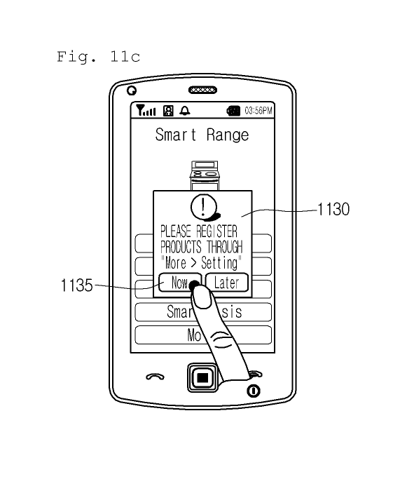

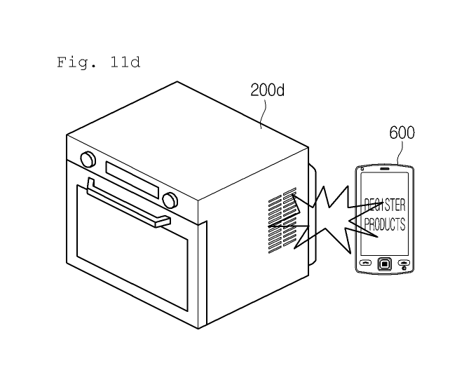

FIG. 10A shows how a home appliance related application execution screen is displayed on the mobile terminal 600.

According to a user input, when the mobile terminal 600 provides a home appliance related application execution input, the control unit 680 of the mobile terminal 600 allows a pre-installed home appliance related application to be executed.

On the other hand, when the home appliance related application is not installed, the mobile terminal 600 may access the server 500, download and install the home appliance related application in the mobile terminal 600.

In this case, the home appliance may be in a turned off state according to step S804 described above.

Next, if a certain mode item in the executed application is selected according to a user input, the mobile terminal 600 selects a corresponding item in step S715 and displays a corresponding mode screen in step S720. On the other hand, step S915 of FIG. 9 corresponds to step S715 of FIG. 7 and step S920 of FIG. 9 corresponds to step S720 of FIG. 7.

FIG. 10A illustrates that the home appliance related application execution screen is displayed on the mobile terminal 600 and then a ‘smart diagnosis’ item 1010, an item for the failure diagnosis of the home appliance is selected by a user input. Thus, the ‘smart diagnosis’ item 1010 may be highlighted.

Next, FIG. 10B illustrates that a smart diagnosis screen 1020 after the selection of the item ‘smart diagnosis’ 1010 of FIG. 10A is displayed on the mobile terminal 600.

In particular, the smart diagnosis screen 1020 of FIG. 10B may include the ‘NFC diagnosis’ item, a diagnosis scheme using NFC.

If the ‘NFC diagnosis’ item is selected by a user input, an ‘NFC diagnosis’ item 1025 may be highlighted. On the other hand, if the ‘NFC diagnosis’ item is selected by a user input, the mobile terminal 600 may display an ‘NFC diagnosis’ related screen.

Next, the mobile terminal 600 determines whether tagging with the home appliance exists, in step S740. If positive, the mobile terminal 600 receives information related to a corresponding mode from the home appliance in step S745. On the other hand, step S940 of FIG. 9 corresponds to step S740 of FIG. 7 or step S840 of FIG. 8, and step S945 of FIG. 9 corresponds to step S745 of FIG. 7 or step S845 of FIG. 8.

FIG. 10C illustrates when the mobile terminal 600 moves close to the washing machine 200b, namely when being tagged with the washing machine.

If the mobile terminal moves to the washing machine 200b to be within a certain distance that enables NFC, the NFC module 617 of the mobile terminal 600 may provide a magnetic field to the washing machine 200b. Alternatively, the NFC module 217 of the washing machine 200b may provide a magnetic field to the mobile terminal 600.

In addition, the mobile terminal 600 reads or receives product information from the memory 218 of the NFC module 217 of the washing machine 200b by using the magnetic field. In this case, the mobile terminal 600 may determine by using the read or received product information whether the washing machine is a pre-registered washing machine, namely, whether the washing machine is a washing machine that enables NFC.

That is, the mobile terminal 600 performs authentication by using the received product information and if the authentication is completed, the mobile terminal 600 may read or receive home appliance related information stored in the memory 218 of the NFC module 217.

In particular, the received home appliance related information may be stored in the memory 618 of the NFC module 617 of the mobile terminal 600. In addition, the NFC control unit 626 of the NFC module 617 of the mobile terminal 600 may inform the control unit 680 of the mobile terminal 600 that the memory 618 has received the home appliance related information. For example, by changing a reception flag from ‘0’ to ‘1’, it is possible to inform the control unit 680 of the mobile terminal 600 that the home appliance related information has been received.

On the other hand, the home appliance related information transmitted to the mobile terminal 600 may be information related to a screen that is displayed on the mobile terminal 600.

That is, the mobile terminal 600 performs authentication by using received product information and if the authentication is completed, the mobile terminal 600 may read or receive only information related to a screen displayed on the mobile terminal 600, among the home appliance related information that is stored in the memory 218 of the NFC module 217.

For example, as shown in FIG. 10B, if the ‘NFC diagnosis’ item 2025 is selected, the mobile terminal 600 may receive read or receive only failure information on the home appliance.

FIG. 10D illustrates that by the tagging of FIG. 10C, failure information Sdia on the washing machine 200b is transmitted from the washing machine 200b to the mobile terminal 600. Accordingly, the mobile terminal 600 may easily obtain information related to a displayed screen from the washing machine 200b.

Next, the mobile terminal 600 transmits the received information to the server in step S760. In addition, the mobile terminal 600 receives result information corresponding to information received from the server in step S765. In addition, the result information is displayed on the display unit in step S770. On the other hand, step S960 of FIG. 9 corresponds to S760 of FIG. 7, step S965 of FIG. 9 corresponds to step S765 of FIG. 7, and step S970 of FIG. 9 corresponds to step S770 of FIG. 7.

FIG. 10E illustrates that by tagging, the obtained washing machine failure information Sdia is transmitted from the mobile terminal 600 to the server 500 and washing machine failure result information Sres corresponding to the washing machine failure information Sdia is transmitted from the server 500 to the mobile terminal 600.

Here, the mobile communication module 613 or the wireless internet module 615 of the wireless communication unit 610 of the mobile terminal 600 transmits the obtained washing machine failure information Sdia to the server 500.

The communication module 530 of the server 500 receives the washing machine failure information Sdia and delivers received information to the processor 520. The processor 520 may generate the washing machine failure result information Sres such as failure cause, failure details, troubleshooting, based on the washing machine failure information by using diagnosis data stored in the storage unit 540 or by using an external server.

In addition, the communication module 530 of the server 500 may transmit the generated washing machine failure result information Sres to the mobile terminal 600.

The mobile terminal 600 may receive the washing machine failure result information Sres and display the received information on the display unit 651.

FIG. 10F illustrates that failure result information 1030 based on the washing machine failure result information Sres of FIG. 10E is displayed on the display unit.

FIG. 10F illustrates that the sentence ‘A water outlet is frozen’ is displayed as the washing machine failure result information 1030. Thus, a user may easily grasp washing machine's failure cause, so user's convenience of use may be enhanced.

On the other hand, the mobile terminal 600 may further display an AS request item 1035 in addition to the washing machine failure result information 1030.

If the AS request item 1035 is selected by a user input in FIG. 10F, an AS request screen 1040 may be displayed as shown in FIG. 10G. Thus, the user may immediately perform AS request in addition to seeing the failure result information, so user's convenience of use may be enhanced.

On the other hand, FIGS. 10A to 10G illustrate that if the mobile terminal 600 tags the turned-off home appliance 200, failure information Sdia related to an NFC diagnosis item displayed on the mobile terminal 600 is transmitted to the mobile terminal, result information Sres on the transmitted information is transmitted from the server 500 to the mobile terminal 600.

Various variations on the embodiments of FIGS. 10A to 10G may be made.

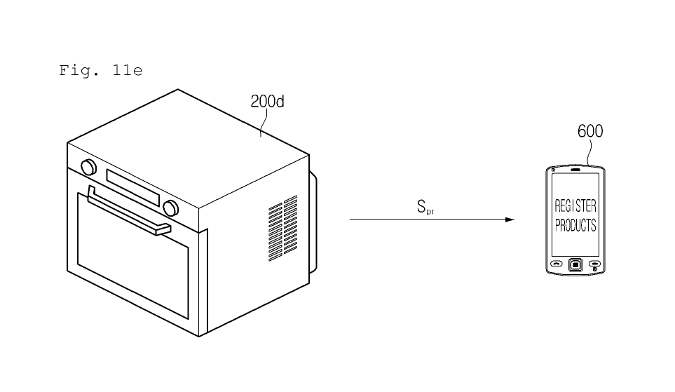

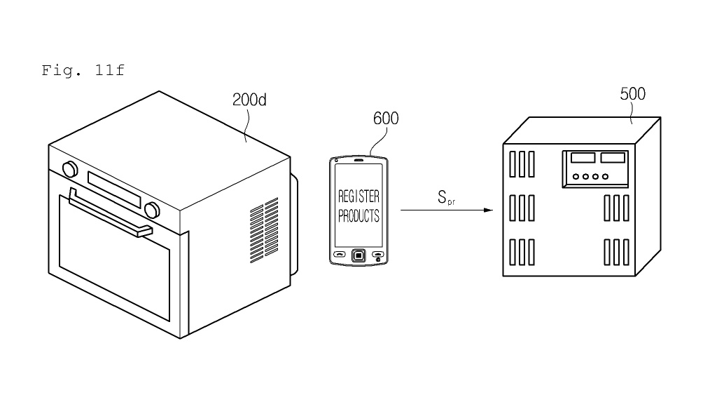

FIGS. 11A to 11F illustrate that if the mobile terminal 600 is tagged to a turned-off home cooking device 200d, product information Spr related to a product registration item displayed on the mobile terminal 600 is transmitted to the mobile terminal 600 and result information on the transmitted information is transmitted from the server 500 to the mobile terminal 600.

FIG. 11A illustrates that a home appliance related application is executed and a home appliance related application screen 1110 is displayed on the mobile terminal 600.

Next, FIG. 11B illustrates a ‘more’ item 1125 on the home appliance related application screen 1120 is selected. Thus, as shown in FIG. 11C, a product registration screen 1135 may be displayed. In addition, FIG. 11C illustrates that a product registration item 1135 on the product registration screen 1130 is selected.

FIG. 11D illustrates when moving the mobile terminal 600 to be within a predetermined distance from the cooking device 200d, namely, when tagging, after the product registration item 1135 is selected.

Thus, as shown in FIG. 11E, the mobile terminal 600 may receive product information Spr from the NFC module 217 of the cooking device 200d. Here, the product information may be a concept that includes product type (cooking device) information, product's manufactured date information, and product serial number information.

FIG. 11F illustrates that the mobile terminal 600 transmits the received product information Spr to the server 500. Thus, the server 500 may complete product registration by using the received product information Spr. Accordingly, it is possible to simply complete product registration.

FIG. 11G illustrates that the server 500 transmits product registration completion result information Sres to the mobile terminal 600 if the product registration is completed.

Thus, the mobile terminal 600 may display a received product registration completion result screen 1160 as shown in FIG. 11H. On the other hand, if a product registration completion item 1165 on the product registration completion result screen 1160 is selected, a login screen 1110 of home appliance related application screens may be again displayed as shown in FIG. 11A.

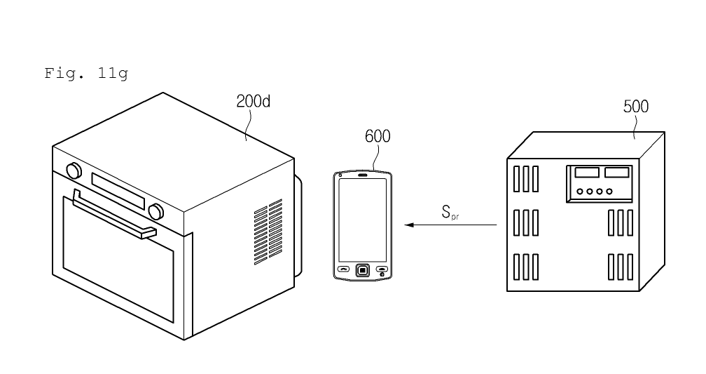

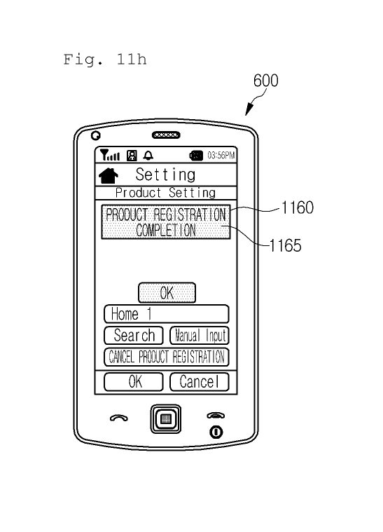

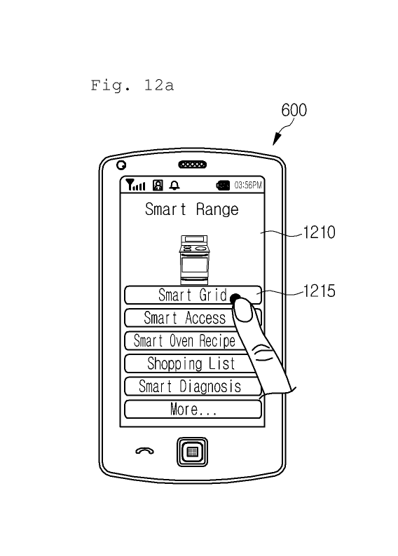

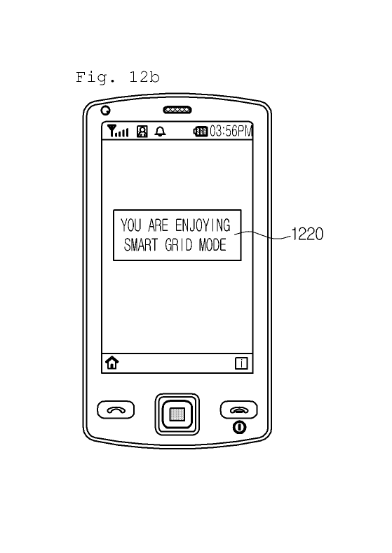

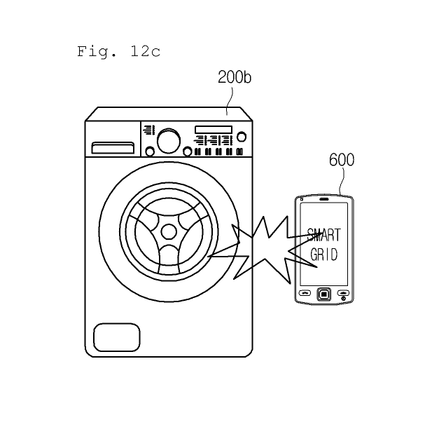

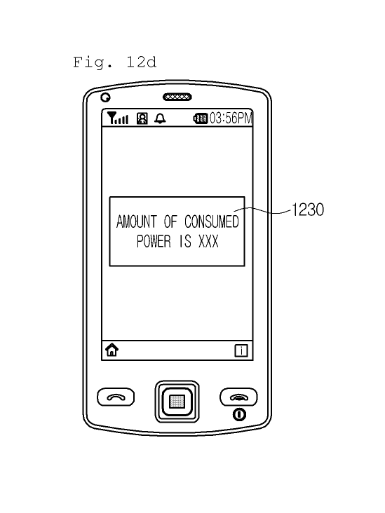

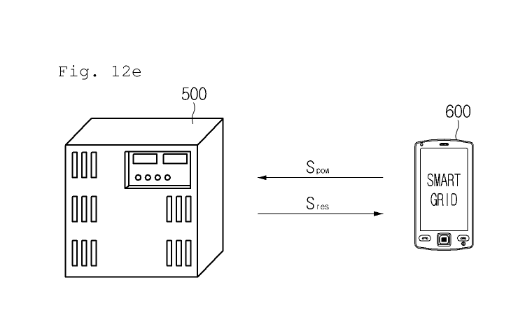

Next, FIGS. 12A to 12F illustrate that if the mobile terminal 600 tags a turned-off washing machine 200b, power consumption information Spow related to a smart grid item displayed on the mobile terminal 600 is transmitted and result information on the transmitted information is transmitted from the server 500 to the mobile terminal 600.

FIG. 12A illustrates that a home appliance relates application is executed and a home appliance related application screen 1210 is displayed on the mobile terminal 600. If a smart grid item 1215 on the home appliance related application screen 1210 is selected, a smart grid related screen may be displayed on the mobile terminal 600.

Next, FIG. 12B illustrates that a smart grid related screen 1220 is displayed on the mobile terminal.

FIG. 12C illustrates when the mobile terminal 600 moves to be within a predetermined distance from the washing machine 200b, namely, when tagging, after the smart grid related screen 1220 is selected on the mobile terminal 600.

Thus, the mobile terminal 600 may receive the power consumption information Spow from the NFC module 217 of the washing machine 200b. Here, the power consumption information Spow may be a concept that includes information an amount of power consumption within a specific period.

FIG. 12D illustrates that the mobile terminal 600 displays the power consumption information Spow received from the NFC module 217 of the washing machine 200b. Accordingly, a user may simply grasp the amount of power consumption.

Next, FIG. 12E illustrates that the mobile terminal 600 transmits the received power consumption information Spow to the server 500. Thus, the server 500 may generate result information by using the received power consumption information Spow and transmit the generated information to the mobile terminal 600. Here, the result information Sres may include power information that includes recommendable power saving information, peak time information, and power price information.

FIG. 12F illustrates that the mobile terminal 600 displays a recommendation operation information screen 1240 by using the received result information Sres. Accordingly, a user may simply grasp a suitable power saving operation corresponding to the power consumption of a home appliance.

If a recommendation operation item on the recommendation operation information screen 1240 is selected, the mobile terminal 600 may practice remote control on the home appliance so that the home appliance operates according to the recommendation operation information. As an example, “a first operation mode” displayed on FIG. 12F may be understood as an operation mode in which the home appliance operates when power rates are equal to or lower than a preset reference value, namely, at an off-peak time. On the other hand, a power control mode 1245 may be separately displayed on the mobile terminal 600 to remote control power for the home appliance. As an example, result information received from the server, namely, peak time information or power price information may be displayed on the mobile terminal 600, and a user may adjust the operation time of the home appliance based on the displayed information.

The mobile terminal, home appliance and operating method thereof according to the embodiments may not be limited to the configuration and method of the above-described embodiments but all or some of the embodiments may be selectively combined so that various variations on the embodiments may be made.

On the other hand, the method of operating the mobile terminal or the home appliance according to the present invention may be implemented as processor readable codes on a recording medium that a processor of the mobile terminal or the home appliance may read. The processor readable recording medium includes all types of recording devices that store processor readable data. Examples of the processor readable recording medium are a ROM, a RAM, a CD-ROM, a magnetic tape, a floppy disc, an optical storage device, etc. and a type of a carrier wave such as transmission through the internet may also be included. Moreover, the processor readable recording medium may be distributed over a networked computer system so that processor readable codes may be stored and executed in a distribution fashion.

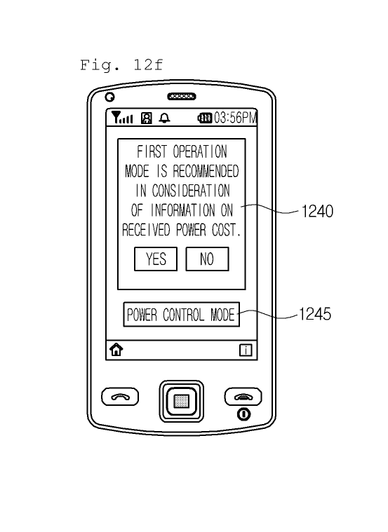

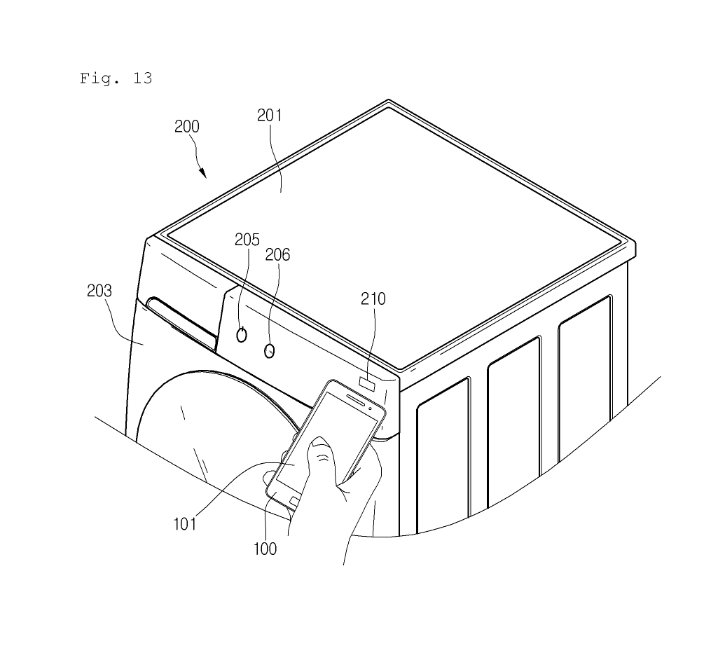

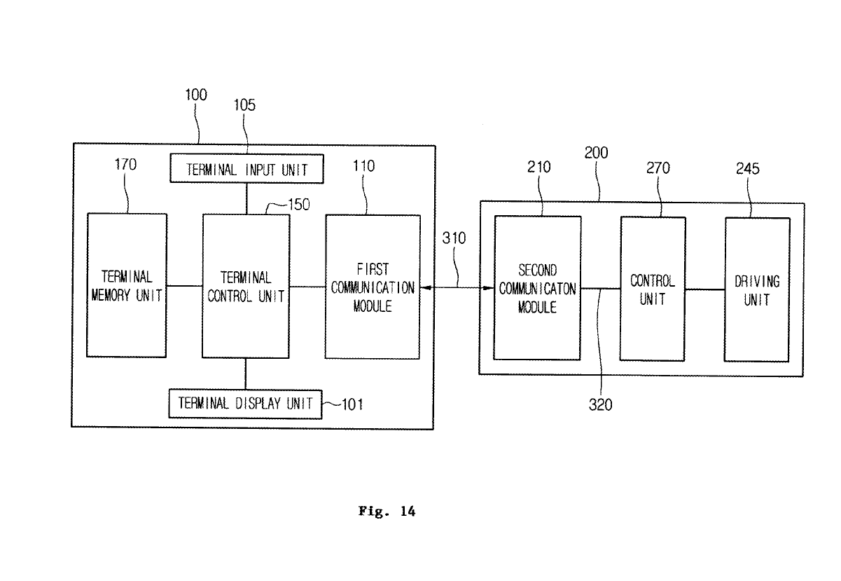

FIG. 13 shows a home appliance and a mobile terminal according to another embodiment, FIG. 14 is a block diagram of a home appliance and a mobile terminal according to another embodiment, and FIG. 15 is a block diagram of a communication module of a home appliance according to another embodiment

Referring to FIGS. 13 to 15, a network system according to another embodiment includes a mobile terminal 100 and a home appliance 200. The mobile terminal 100 is connected to the home appliance 200 to be able to communicate with each other, and the home appliance 200 may be monitored or controlled by using the mobile terminal 100.

Although FIG. 13 shows a washing machine as a type of a home appliance, an electrical product is not limited thereto.

The mobile terminal 100 includes a first communication module 110 provided to be able to communicate with the home appliance 200, and a terminal display unit 101.

The home appliance 200 includes a body 201, input units 205 and 206, and a second communication module 210 that may recognize the first communication module 110. As an example, the input units 205 and 206 and the second communication module 210 may be arranged on a front unit 203 that forms the front surface of the body 201.

Here, the first communication module 110 and the second communication module 210 may correspond to the NFC module 617 of the mobile terminal and the NFC module 217 of the home appliance that are described in the previous embodiments.

Operation conditions for driving the home appliance 200 may be input through the input units 205 and 206.

In particular, the input unit 205 is a power input unit 205 to turn on or off the home appliance 200 and the input unit 206 is a start/end input unit 206 to start or end the operation of the home appliance while the home appliance 200 is turned on.

The input units 205 and 206 may be configured as a touch screen type or a button type. In addition, a separate input unit other than the input units 205 and 206 or a display unit is not arranged on the front unit 203.

That is, the home appliance 200 may include only minimum input units for the operation of an electrical product and most input units for inputting commands to be input for the operation of the home appliance 200, for example, for setting the operation course of the home appliance 200 may be arranged in the mobile terminal 100.

In summary, a product function, namely, a function to input certain commands for setting an operation course is limited in the home appliance 200 and the command input may be executed through the mobile terminal 100. In other words, the number of commands that may be input through the mobile terminal 100 may be more than that of commands that may be input through the home appliance 200.

In particular, the mobile terminal 100 includes a terminal display unit 101 on which information on the operation of the home appliance 200 or information on data transmission/reception is displayed. Information on the data transmission/reception may include a state in which the information is transmitted, or result information on the transmission.

The information on the operation of the home appliance 200 includes information on the on/off of the home appliance 200, the start or end of an operation, or an operation course. In addition, information on the data transmission/reception may include information on data that is transmitted from the home appliance 200 to the mobile terminal 100, or on data that is transmitted from the mobile terminal 100 to the home appliance 200.

The data that is transmitted from the home appliance to the mobile terminal 100 may include information during the driving of the home appliance, for example, information on the operation error of the home appliance.

In addition, the data that is transmitted from the mobile terminal 100 to the home appliance 200 may be information on the operation course of the home appliance as information required for driving the home appliance and include, for example, washing course information on a washing machine or cook data on a cooking device.

On the other hand, information on the operation of the home appliance 200 and data transmitted from the home appliance 200 to the mobile terminal may be information that is generated from the inside of the home appliance 200 (hereinafter, referred to as information inside an electrical product).

On the other hand, information on the data transmitted from the mobile terminal 100 to the home appliance 200 may be information that is generated from the outside of the home appliance 200 (hereinafter, referred to as information outside the home appliance).

Displaying the information generated from the inside of the home appliance 200 or the information generated from the outside of the home appliance 200 on the home appliance 200 is limited and they may be displayed on the terminal display unit 101.

In other words, in order that information that may not be displayed on the home appliance 200 among the information generated from the inside of the home appliance 200 and the information generated from the outside of the home appliance 200 may be displayed on the terminal display unit 101, the control unit 270 of the home appliance 200 is configured to be able to transmit the information to the mobile terminal 100.

The mobile terminal 100 includes a terminal input unit 105 that may input certain commands for the operation of the home appliance or for data transmission/reception.

The terminal input unit 105 may be configured as a touch screen type in the terminal display unit or as a button type separately from the terminal display unit 101.

The mobile terminal 100 further includes a terminal memory unit 170 that includes information on certain programs, for example, applications to performs communication with the home appliance 200, and a terminal control unit 150 that controls the terminal memory unit 170 and the first communication module 110.

The home appliance 200 includes a driving unit 245 that is driven to perform the function of the home appliance 200, and a control unit 270 that controls the second communication module 210 and the driving unit 245. The driving unit may include a motor and a heater.

The control unit 270 may write the information inside the home appliance 200 to the second communication module 210 or read the outside information from the second communication module 210.

A first interface 310 as a communication type may be defined between the first communication module 110 and the second communication module 210. As an example, the first interface includes the NFC type.

The NFC is one of RFID technologies, which is a contact-less communication technology using a specific frequency 13.56 MHz band. Since the communication distance between devices is short, the NFC has advantages in that security is relatively excellent and cost is low.

Thus, the first communication module 110 and the second communication module 210 are understood as communication modules for performing NFC functions and may have the same configuration. For convenience of description, the first communication module 110 or the second communication module 210 is named as a “NFC module” below.

If the mobile terminal 100 moves to be within a preset distance from the home appliance 200, namely, if the first communication module 110 is within a preset distance from the second communication module 210, the tagging of the mobile terminal 100 is performed. If the tagging is performed, the communication between the mobile terminal 100 and the home appliance 200 is performed and data transmission/reception is done.

A second interface 320 as another communication type may be defined between the second communication module 210 and the control unit 270. As an example, the second interface 320 may include an Inter-integrated Circuit (12C) type.

The second communication module 210 includes a module recognition unit 211 that recognizes the approach of the first communication module 110 if the first communication module 110 moves to be within a preset distance therefrom. As an example, the module recognition unit 211 may be an antenna.

The second communication module 210 further includes a memory unit 220 that stores information on the home appliance 200. The memory unit 220 includes a plurality of memory areas 221, 223 and 225 that are divided to store different information.

The memory area 221 is a first memory area 221 in which unique information on the home appliance, information on communication, or information on installation is stored, the memory area 223 is a second memory area 223 in which information generated from the inside of the home appliance 200 is stored, and the memory area 225 is a third memory area 225 in which information received from the outside as information related to the operation of the home appliance 200 is stored.

The third memory area 221 stores unique information on the home appliance, for example, information on the type (washing machine, cooking device, refrigerator) of the home appliance, information on the model name of the home appliance, a unique ID of the home appliance (even in the case of the same model name, ID may vary), information on a program (software related to an operation course) required for driving the home appliance.

The information on the communication may include information on the first interface 310 or the second interface 320. In addition, the information on the installation may include information on the installation country or region of the electrical product 200.

The second memory area 223 may store information generated while driving the home appliance 200, for example, information on an error or information on an error diagnosis result if the error occurs while driving the home appliance 200.

If the home appliance 200 has an error, the control unit 270 may write information on the error or information on a diagnosis result of the home appliance to the second memory area 223 at a preset time. Thus, the second memory area 223 may be understood as a memory area to which the control unit 250 may write.

If the control unit 270 performs the writing, the mobile terminal 100 may read information from the second memory area 223.

Here, the preset time may be any one of immediately when the home appliance 200 has an error, when an operation course is completed if the error occurs while the home appliance 200 perform the operation course, and when the home appliance 200 is turned off.

As an example, when the home appliance 200 has the error and a time arrives at the preset time, information that the error has occurred may be displayed on the display unit 206 of the home appliance 200. If the information that the error has occurred is displayed on the display unit 206, it is possible to check information on the error of the home appliance 200 by using the mobile terminal 100.

In particular, if the mobile terminal 100 approaches the home appliance 200 and the module recognition unit 211 recognizes the first communication module 110, the inside information (error occurrence information) may be transmitted from the second memory area 223 to the mobile terminal 100. That is, the mobile terminal 100 may read the inside information from the second memory area 223.

On the other hand, if the information on the error is stored in the second memory area 223, the information on the error may be transmitted to the terminal 100 and the terminal 100 may perform diagnosis on the error.

On the other hand, when information on the error diagnosis result is stored in the second memory area 223, it may be understood that the control unit 250 performs diagnosis on the error and stores a diagnosis result in the second memory area 223.

Moreover, the second memory area 223 may include information on power consumed while driving the home appliance 200. The mobile terminal 100 may move to be within a preset distance from the home appliance 200 and read information on the power.

The third memory area 225 may store outside information transmitted from the mobile terminal 100.

The outside information includes information on the operation course of the home appliance 200. As an example, when the home appliance 200 is a washing machine, the outside information may be washing course information on the washing machine. In addition, when the home appliance 200 is a cooking device, the outside information may be cook data on the cooking device.

The home appliance 200 is understood as a product driving the driving unit 245 according to a certain course and the home appliance 200 may store one or more operation courses. In addition, the operation course may be updated and such an update may be made through the mobile terminal 100.

In particular, the mobile terminal 100 may store information on the operation course of the home appliance 200 or update information, namely, outside information. As an example, the mobile terminal 100 may be connected to a certain server (not shown), download and store information from the server.

If the mobile terminal 100 moves to be within a preset distance from the home appliance 200, the module recognition unit 211 may recognize the first communication module 110 and the information stored in the mobile terminal 100 may be stored in the third memory area 225. That is, the mobile terminal 100 may write the information to the third memory area 225.

In addition, the control unit 270 may read outside information from the third memory area 225. In addition, the read information may be stored in the main memory (not shown) of the home appliance 200. As a result, the third memory area 225 may be understood as a memory area that the control unit 270 may read.

As such, the outside information (operation course information) transmitted from the mobile terminal 100 to the home appliance 200 is update information on the home appliance 200 and may be reflected to the operation of the home appliance.

On the other hand, the outside information stored in the second memory area 223 or the outside information stored in the third memory area 225 may be overwritten if new information is generated.

That is, since the inside information or the outside information is information that keeps on being generated over time, existing information is deleted and new information may be stored in the second memory area 223 or the third memory area 225, if the new information is generated.

FIG. 16 is a flow chart of a method of controlling a home appliance according to another embodiment.

Firstly, the application of the mobile terminal 100 may be executed. The application may be executed after the “NFC mode” of a plurality of communication modes that is defined on the mobile terminal 100 becomes on. If attempting to execute the application while the “NFC mode” is off, the mobile terminal 100 may output a message (screen or voice) representing that the “NFC mode” needs to be on.

If the application is executed, the mobile terminal 100 may receive the information inside the home appliance 200 or transmit information required for the operation of the home appliance 200 (outside information) to the home appliance 200, in step S11.

In addition, the application includes a plurality of modes in which data may be transmitted or received by using the NFC type.

It is possible to execute a specific data transmission/reception mode of such modes.

In particular, a first transmission/reception mode may be a mode in which information generated from the inside of the home appliance 200 (inside information) is transmitted to the mobile terminal 100.

As an example, the first transmission/reception mode may be a mode in which information on error details or information on an error diagnosis result is transmitted to the mobile terminal 100 if an error in the operation of the home appliance 200 occurs.

A second transmission/reception mode may be a mode in which information generated from the outside (outside information) that is required for the operation of the home appliance is received from the mobile terminal 100.

As an example, the second transmission/reception mode may be a mode in which information on the operation course of the home appliance 200 may be transmitted from the mobile terminal 100 to the home appliance 200. Here, when the home appliance 200 is a washing machine, the information on the operation course may be information on a washing course, and when the home appliance 200 is a cooking device, the information on the operation course may be information on a recipe.

A third transmission/reception mode may be a mode in which operation information on two or more linkable products is transmitted to the terminal 100.

As an example, the two or more linkable products may include a plurality of home appliances 200. That is, when information generated from one home appliance 200, for example, operation information on the one home appliance is utilized as information required for the operation of the other home appliance 200, such home appliances may be understood as linkable home appliances 200.

In this case, the mobile terminal 100 may receive information on the link between the one home appliance and the other home appliance.

For example, the plurality of home appliances 200 may include a washing machine and a drying machine, and information on the operation of the home appliance may include information on a washing or drying course and information on laundry or a drying target.

As another example, the plurality of home appliances may include a cooking device and an air conditioner, and information on the operation of the home appliance may information on recipe or on an air conditioning course and information on an amount of contaminants or on an air conditioning capability.

As another example, the plurality of home appliances 200 may include a cooking device and a refrigerator, and information on the operation of the home appliance may include information on the stored goods of the refrigerator or the cooking target of the cooking device and information on recipe.

On the other hand, the two or more linkable products may include a home appliance and a server. That is, the server may be understood as a product for storing information required for the operation of the home appliance or information on an operation result.

In this case, the mobile terminal 100 may receive information on the link between the home appliance and the server in step S12.

While one of the transmission/reception modes is executed, the mobile terminal 100 may move to be within a preset distance from the home appliance 200 so that the module recognition unit 211 may recognize the first communication module 110. That is, the mobile terminal 100 may be tagged with the home appliance 200 in step S13.

If the module recognition 211 recognizes the first communication module 110, data transmission/reception may be performed. That is, the information inside the home appliance 200 is transmitted from the home appliance 200 to the mobile terminal 100 or the outside information is transmitted from the mobile terminal 100 to the home appliance 200.

While the data, namely, the inside information or the outside information is transmitted, the display unit 206 of the home appliance 200 or the display unit 101 of the mobile terminal 100 may display information on the progress on the data transmission or reception, in step S14.

If the transmission of the inside information or the outside information is completed, information representing that the data transmission/reception has been completed may be displayed to the outside. As an example, a transmission completion message may be displayed on the display unit 206 of the home appliance 200 or the display unit 101 of the mobile terminal 100, or a beep may be output to the outside.

As an example, if information on an error or on an error diagnosis result among the inside information is transmitted to the mobile terminal 100, the display unit 101 of the mobile terminal 100 may display information on the error diagnosis result or a diagnosis completion message in step S15.

Control methods that are divided according to a type of transmitted information will be described below in detail with reference to the drawings.

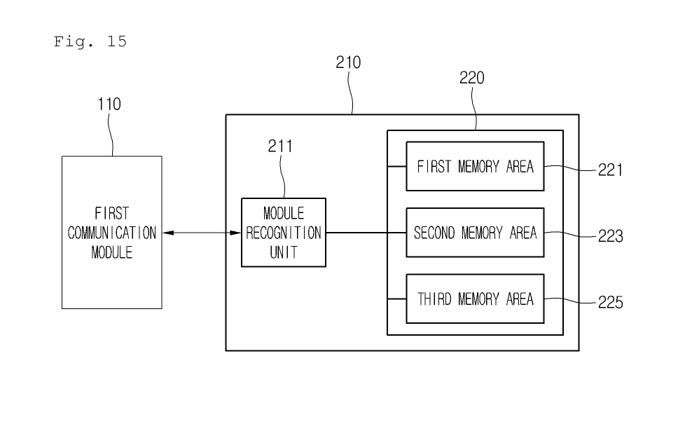

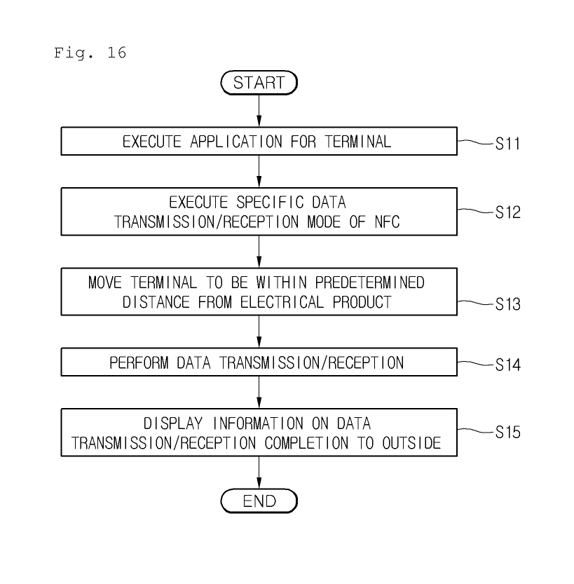

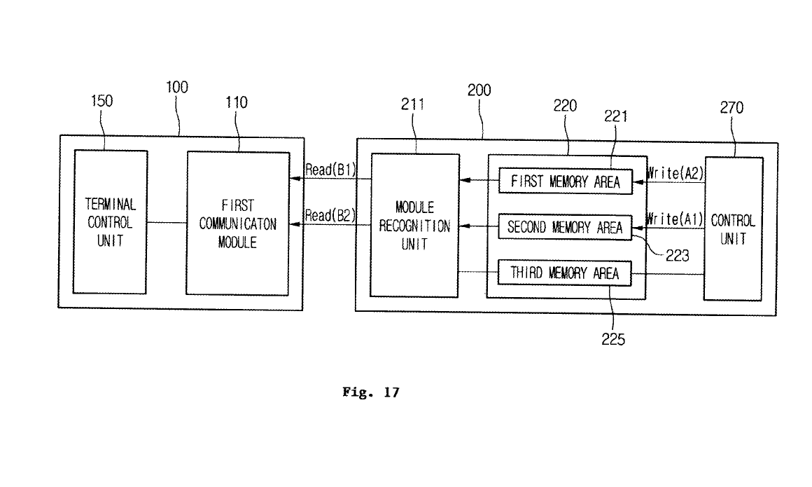

FIG. 17 is a block diagram of how information inside a home appliance is transmitted to a terminal according to another embodiment. FIG. 17 shows a control method of transmitting information generated from the inside of the home appliance 200 to the mobile terminal 100.

Firstly, if certain information is generated from the inside of the home appliance, the control unit 270 writes the inside information to the second memory area 223. The inside information may include error information or power consumption information on the home appliance.

As an example, when the inside information is the error information on the home appliance, the control unit 270 checks whether the second communication module 210 is in an NFC writable mode as soon as an error occurs, after the operation course of the home appliance is completed or when an electrical product is turned off.

When the second communication module 210 is in the NFC writable mode, the error information is written to the second memory area 223.

In this case, the control unit 270 writes verification information along with the error information. After writing, the control unit 270 completes writing by reading the verification information back from the second memory area 223 in operation Write (A1).

On the other hand, the control unit 270 may check unique information on the home appliance 200, information on communication or information on installation (hereinafter, referred to as unique information) and update the first memory area 221. In this case, when there is information to be changed or updated, the control unit 270 may write change or update information to the first memory area 221 in operation Write (A2).

After the mobile terminal 100 executes an application and a specific data transmission/reception mode and then moves to be within a preset distance from the home appliance 200, the mobile terminal 100 reads unique information on the electrical product 200, information on communication or information on installation. In this process, the mobile terminal 100 checks whether the home appliance 200 is a home appliance suitable for communication, in operation Read B1.

In addition, the mobile terminal 100 may read the error information. In this case, the mobile terminal 100 may also read the verification information in operation Read (B2).

As such, since information generated from the inside of the home appliance may be checked or diagnosed by using a terminal, there is an effect in that convenience of use is enhanced.

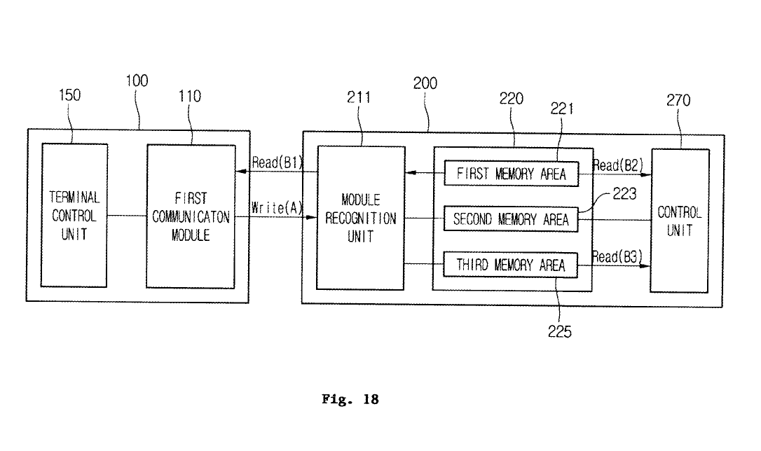

FIG. 18 is a block diagram of how outside information is transmitted to a home appliance according to another embodiment. FIG. 18 shows a control method of transmitting information generated from the outside of the home appliance 200 from the mobile terminal to the home appliance 200.

The mobile terminal 100 may write the outside information to the home appliance 200. As an example, the outside information includes information on an operation course required for the operation of the home appliance 200. In particular, when the home appliance 200 is a washing machine, the outside information washing course information, and when being a cooking device, the outside information may be cooking course information.

Firstly, after the mobile terminal 100 executes an application and a specific data transmission/reception mode and then moves to be within a preset distance from the home appliance 200, the mobile terminal 100 reads unique information on the home appliance 200, information on communication or information on installation. In this process, the mobile terminal 100 checks whether the home appliance 200 is a home appliance suitable for communication, in operation Read B1.

In addition the mobile terminal 100 writes the outside information along with verification information to the third memory area 223. After writing, the mobile terminal 100 completes writing by reading the verification information back from the third memory area 225, in operation Write (A).

The control unit 270 checks whether the second communication module 210 is in an NFC writable mode. If the second communication module 210 is in the NFC writable mode, the control unit 270 reads the unique information on the home appliance stored in the first memory area 221 and checks whether communication is possible, in operation Read (B1).

When the second communication module 210 is in the NFC writable mode, the control unit 270 reads the unique information on the home appliance stored in the first memory area 221 and checks whether communication is possible, in operation Read (B2).

In addition, the control unit 270 completes reading, by reading, along with the verification information, the outside information stored in the third memory area 225, in operation Read (B3). The read outside information may be reflected as information for the operation of the home appliance.

As such, since the home appliance may receive certain information from the mobile terminal and update information on a course required for the operation of the home appliance, there is an effect in that it is possible to smartly use a home appliance.

FIG. 19 is a flow chart of a method of controlling a home appliance according to another embodiment. A method of controlling a home appliance according to the embodiment will be described with reference to FIG. 19.

Firstly, the NFC mode of the mobile terminal 100 becomes on and then an application may be executed. If the application is executed, the mobile terminal 100 may receive the information inside the home appliance 200 or transmit information required for the operation of the home appliance 200 (outside information) to the home appliance 200, in step S21.

In addition, it is possible to execute a specific data transmission/reception mode that is one of a plurality of transmission/reception modes stored in the application. In the present embodiment, the specific data transmission/reception mode may include a power change mode or a “my course” mode, in step S22.

It is recognized whether the transmission/reception mode is the power change mode (a fourth transmission/reception mode). The power change mode is understood as a mode for turning on or off the home appliance 200.

As an example, if the home appliance 200 is turned on and then the mobile terminal 100 is tagged, the home appliance 200 is turned off, and if the home appliance 200 is turned off and then the mobile terminal 100 is tagged, the home appliance 200 is turned on, in step S23. When the transmission/reception mode is the power change mode, the home appliance 200 changes a change to be turned on or off if the mobile terminal 100 moves to be within a preset distance from the home appliance 200, namely, if the mobile terminal 100 is tagged to the home appliance 200, in step S24.

On the other hand, it may be recognized whether the transmission/reception mode is the “my course” mode (a fifth transmission/reception mode). The my course mode is understood as at least one mode pre-selected and stored by a user that is one of a plurality of operation courses executable by the home appliance 200. That is, a user may designate a frequently-used operation course as a “my course” and store it in the mobile terminal 100 or home appliance 200, in step S25.

When the transmission/reception mode is the “my course”, the home appliance 200 may execute the “my course” preset according to the “my course” execution command of the mobile terminal 100 if the mobile terminal 100 is tagged to the home appliance 200.

That is, the control unit 270 may control the driving unit 245 to be driven according to the “my course” in step S26.

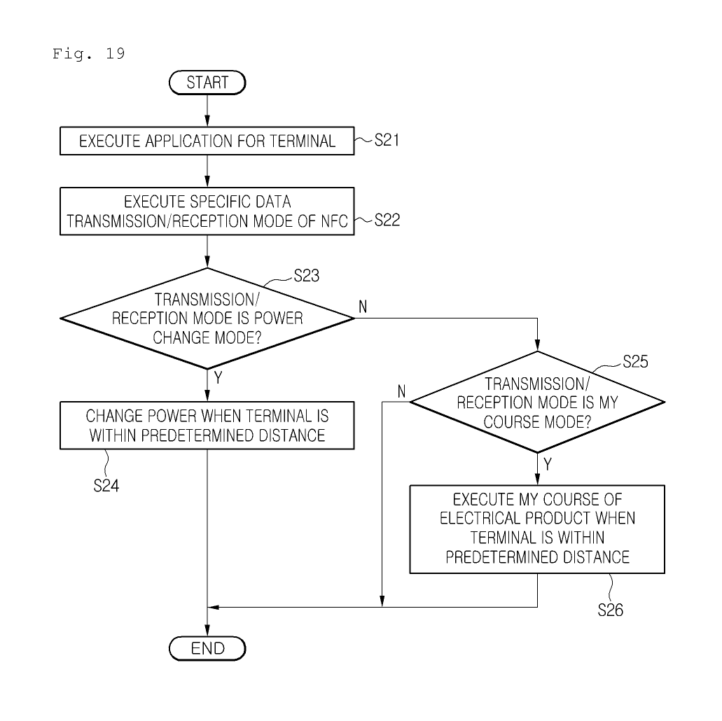

FIG. 20 is a block diagram of a home appliance and a mobile terminal according to another embodiment.

Referring to FIG. 20, a network system according to another embodiment includes a mobile terminal 100, a home appliance 200, and a link device 400. A configuration of the mobile terminal 100 is the same as that of the previous embodiment and thus a detailed description thereof is skipped. The link device 400 may be another home appliance or a server.

The home appliance 200 according to the present embodiment includes a second communication module 210 as an NFC module that is provided to be able to communicate with the mobile terminal 100, and a third communication module 215 that is provided to be able to communicate with the link device 400.

The communication type between the home appliance 200 and the link device 400 may be any one of WiFi, Bluetooth and Zigbee, and a third interface 330 is defined between the third communication module 215 and the link device 400.

By using the configuration according to the present embodiment, a third transmission/reception mode that is one of data transmission/reception modes of a terminal application as described above may be performed. As a result, information on the link between the home appliance 200 and the link device 400 may be monitored or controlled by using the mobile terminal 100.

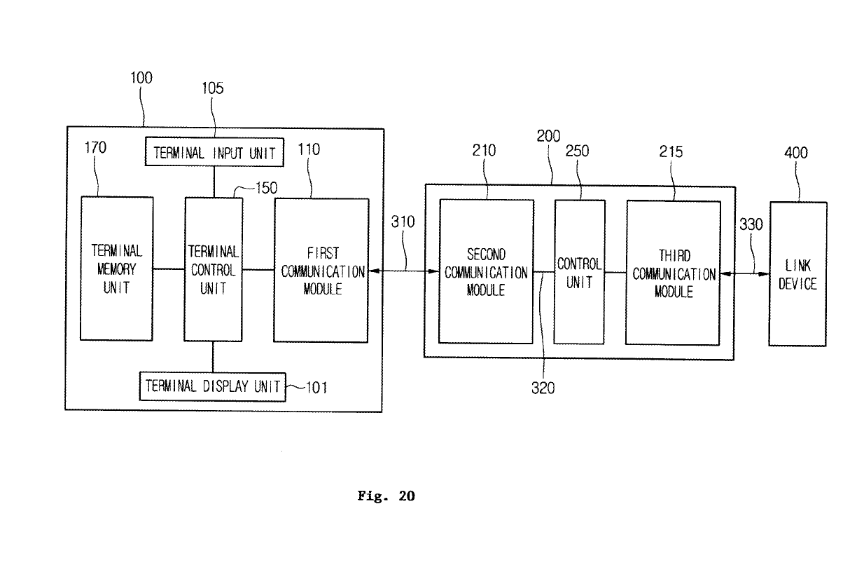

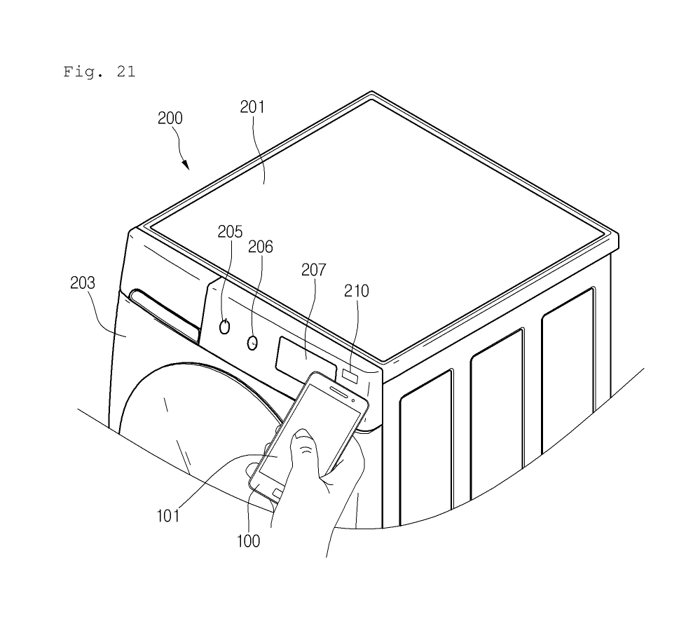

FIG. 21 shows a home appliance and a mobile terminal according to another embodiment.

Referring to FIG. 21, the home appliance according to another embodiment includes a display unit on which information on the operation of the home appliance 200 is displayed.

The display unit 207 may display information on the turning on/off of the home appliance 200 and information on whether to drive the home appliance.

For convenience of description, the display unit of the mobile terminal 100 may be named as a first display unit, and the display unit of the home appliance 200 may be named as a second display unit.

In summary, only basic information on the home appliance may be displayed on the second display unit may display, and detailed information related to the operation of the home appliance in addition to the basic information displayed on the second display unit may be displayed on the first display unit.

As an example, information on the operation course of the home appliance 200, operation error information or power consumption information may be displayed, and when the home appliance 200 is linked to the link device 400, link related information may be displayed.

According to such a configuration, there are advantages in that it is possible to simply implement the display unit 207 and reduce costs and it is possible to neatly implement the front surface of the home appliance 200.

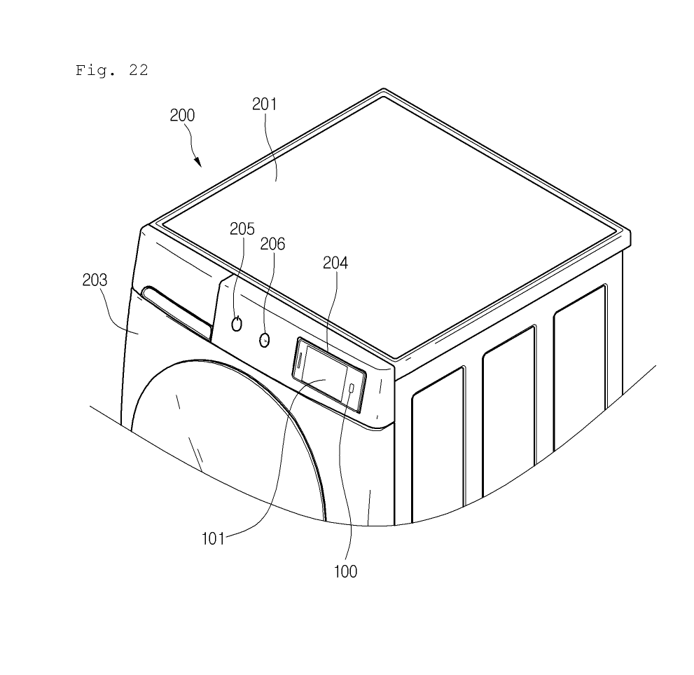

FIG. 22 shows a home appliance according to another embodiment.

Referring to FIG. 22, a home appliance 200 according to another embodiment includes a holding unit 204 on which the mobile terminal 100 is detachably arranged. The holding unit 204 may be concavely configured on the front surface of the home appliance 200.

According to the present embodiment, the home appliance has no separate display units and as needed, the mobile terminal 100 is arranged on the home appliance and utilized as the display unit of the home appliance.

If the mobile terminal 100 is arranged in the holding unit 204, the mobile terminal 100 and the home appliance 200 may communicate with each other in a wired way or wirelessly.

When the mobile terminal 100 and the home appliance 200 are connected in the wired manner, the holding unit 204 may include a unit for recognizing whether the mobile terminal 100 is arranged in the holding unit 204, through not shown. The recognizing unit may include a certain socket structure.

When the mobile terminal 100 and the home appliance 200 are wirelessly connected, the communication module of the mobile terminal 100 and the communication module of the home appliance 200 may perform NFC or Bluetooth communication.

According to embodiments, the mobile terminal may receive pre-stored home appliance information by using NFC even while the home appliance is turned off and thus it is possible to manage the home appliance even while the home appliance is turned off.

In particular, the mobile terminal may transmit received information to a server, receive result information and thus manage the home appliance.

In particular, the mobile terminal may receive state information on the home appliance when the home appliance is out of order, receive diagnosis result information through the server, and thus easily manage the home appliance.

Moreover, the home appliance may regularly store home appliance relate information and thus transmit the home appliance related information to the mobile terminal by using NFC even while the home appliance is turned off. Thus, since a user may manage the home appliance through his/her mobile terminal, user's convenience of use may be enhanced.

Moreover, since the home appliance is connected to the terminal to be able to communicate by using NFC and it is possible to check information related to the operation of the home appliance through the display unit of the mobile terminal, there is an advantage in that it is possible to implement a smart home appliance.

In particular, since information related to the operation of the home appliance is transmitted to the mobile terminal and a user may check the information, the home appliance has no need for a separate display unit or a complex input unit for enabling function selection and thus there is an effect of enabling a compact configuration of the home appliance.

Moreover, since the home appliance and the mobile terminal may communicate through the NFC scheme, there is no need for a separate configuration for inter-device communication and thus there is an advantage in that an additional cost for setting a communication environment decreases.

Moreover, since the NFC communication module includes a memory unit in which memory areas for storing information generated from the inside of the home appliance and information generated from the outside of an electrical product are separately configured, there is an effect in that it is possible to easily transmit and receive specific data.

Moreover, since operation information on two or more linkable products may be transmitted to the mobile terminal and checked through the display unit of the mobile terminal, there is an advantage in that it is easy to monitor or control the linked products.

Moreover, since it is possible to turn on or off an electrical product or control an operation course only with a user operation of putting the mobile terminal on the home appliance, the convenience of operation of the home appliance may be enhanced.

Moreover, since the mobile terminal is arranged on the home appliance and it is possible to use the mobile terminal as the display unit of an electrical product, convenience of use of the electrical product may be enhanced.

According to such a configuration, since it is possible to utilize the terminal as needed without including a separation display unit in the home appliance, the convenience of use may be enhanced.

In addition, although exemplary embodiments have been illustrated and described above, the present disclosure is not limited specific embodiments described above but may be varied by those skilled in the art without departing from the subject matter of the present disclosure claimed in the following claims. Further, these variations should not be understood individually from the technical spirit or perspective of the present disclosure.

What is claimed is:

1. A home appliance using a mobile terminal, the home appliance comprising:
an input unit through which certain commands are input;
a control unit controlling an operation of a driving unit of the home appliance according to the input through the input unit; and
a near field communication (NFC) module connected to the mobile terminal to be able to communicate, the NFC module comprising a memory unit that stores production information or state information on the home appliance, and
if the NFC module is tagged to the mobile terminal, the NFC module transmits information from the memory unit to the mobile terminal.

2. The home appliance of claim 1, wherein if the NFC module is tagged to the mobile terminal while the home appliance is turned off, the NFC module transmits information from the memory unit to the mobile terminal.

3. The home appliance of claim 1, wherein the information transmitted to the mobile terminal is transmitted to a server, and result information received from the server is displayed on the mobile terminal.

4. The home appliance of claim 3, wherein a screen displayed on the mobile terminal is an application screen executable for management or diagnosis of the home appliance.

5. The home appliance of claim 4, wherein when the screen displayed on the mobile terminal is a diagnosis screen for the home appliance, information related to the application screen is state information on the home appliance, and
the result information is diagnosis information based on the state information on the home appliance.

6. The home appliance of claim 4, wherein when the screen displayed on the mobile terminal is a product registration screen for the home appliance, information related to the application screen is home appliance product information, and
the result information is product registration information.

7. The home appliance of claim 4, wherein when the screen displayed on the mobile terminal is a smart grid screen for the home appliance, information related to the application screen is information on an amount of power consumption, and
the result information is recommendation operation information based on the power consumption amount information on the home appliance.

8. The home appliance of claim 1, wherein the control unit controls the NFC module to allow some of information generated from the home appliance to be displayed on the mobile terminal, said some of information not being to display on the home appliance.

9. The home appliance of claim 8, wherein the display unit of the mobile terminal displays at least one of:
information transmitted from the mobile terminal to the home appliance or information transmitted from the home appliance to the mobile terminal,
information on an operation course of the home appliance,
information on an operation error of the home appliance,
information on power consumption of the home appliance, and
information on a link between the home appliance and a link device.

10. The home appliance of claim 1, wherein a plurality of operation commands that selection through the input unit is limited is recognized by the control unit, and
the mobile terminal comprises a terminal input unit that inputs the command selection-limited through the input unit and delivers the command to the control unit.

11. The home appliance of claim 1, wherein the home appliance comprises a front unit on which the input unit and the NFC module are arranged, and
the front unit comprises a holding unit on which the terminal is detachably mounted.

12. The home appliance of claim 1, wherein the control unit is configured to transmit or receive data from the mobile terminal through at least one transmission and reception mode, and
the transmission and reception modes comprises a first transmission and reception in which information generated inside the home appliance is transmitted to the mobile terminal, and
the information generated inside the home appliance comprises power consumption information or operation error information on the home appliance.

13. The home appliance of claim 12, wherein the transmission and reception mode comprises a second transmission and reception mode in which information generated outside the home appliance is transmitted to the mobile terminal, and
the information generated outside the home appliance comprises information on an operation course of the home appliance.

14. The home appliance of claim 12, wherein the transmission and reception module comprises a third transmission and reception mode in which operation information on two or more linkable devices is transmitted to the mobile terminal, and
the two or more linkable devices comprise a plurality of home appliances or one home appliance and a server.

15. The home appliance of claim 12, wherein the transmission and reception mode comprises a fourth transmission and reception mode in which the home appliance changes a state to be on or off, and
if the mobile terminal is tagged, the home appliance changes from an on state to an off state or from an off state to an on state.

16. The home appliance of claim 12, wherein the transmission and reception mode comprises a fifth transmission and reception mode in which information on a preset my course, one of operation courses of the home appliance is transmitted, and
if the mobile terminal is tagged while the fifth transmission and reception mode is set, the control unit controls the driving unit to allow the home appliance to be driven according to said my course.

17. A method of operating a home appliance, the method comprising:
executing an application by a mobile terminal;
executing a transmission and reception mode for specific data through the application;
tagging an NFC module of the mobile terminal to an NFC module of a home appliance; and
transmitting information related to the home appliance from the home appliance to the mobile terminal, or from the mobile terminal to the home appliance.

18. The method of claim 17, wherein if the home appliance is turned on, product information or state information on the home appliance is stored in the NFC module of the home appliance, and
if the tagging is performed while the home appliance is turned off, the information stored in the NFC module of the home appliance is transmitted to the mobile terminal.

19. The method of claim 17, wherein at least some of commands to be input for an operation of the home appliance are input through only the mobile terminal of the home appliance and the mobile terminal.
